(19) United States
(12) Patent Application Publication
(10) Pub. No.: US 2010/0169926 A1
(43) Pub. Date: Jul. 1, 2010

(54) SYSTEMS AND METHODS FOR PROVIDING APPROXIMATED INFORMATION IN AN INTERACTIVE TELEVISION PROGRAM GUIDE

(76) Inventors: Thomas E. Westberg, Stow, MA (US); Glen Dudek, Sudbury, MA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/627,947

(22) Filed: Nov. 30, 2009

Related U.S. Application Data
(63) Continuation of application No. 11/050,368, filed on Feb. 2, 2005, now abandoned.

(51) Int. Cl. H04N 5/445

(52) U.S. Cl. 725/40

(57) ABSTRACT

An interactive television program guide application on an interactive television system that determines approximated information using historical content is provided. The interactive television program guide application may retain and store interactive television program guide information. Using the available information, the interactive television program guide application may determine approximated information when information is not available or has not been received.

### CROSS-REFERENCE TO RELATED APPLICATIONS

This application is a continuation of U.S. application Ser. No. 11/050,368, filed Feb. 2, 2005, the contents of which are incorporated herein by reference in their entirety.

### BACKGROUND OF THE INVENTION

This invention relates to television systems, and more particularly, to interactive television systems with an interactive television program guide application.

Interactive television systems are known to provide interactive television program guide applications. An interactive television program guide application may be configured to provide a number of interactive features, such as television program listings, pay-per-view services, video-on-demand services, web browsing services, games, home shopping, and other interactive features, to the user.

In a typical interactive television system, the interactive television program guide application is implemented using a set-top box with which the user interacts using a remote control or other user interface. The interactive television program guide application generates program guide screens that contain interactive television program guide application information received by the set-top box.

The interactive television program guide application information received by the set-top box is typically appropriate for a specific time frame, such as, for example, the next 12 hours. In some situations, this information may not be timely received or available. When the information is not available, features of the interactive television system may not be functional. For example, a user may be denied access to upcoming program listings because the listings are outside the time period of the interactive television programs guide application's available information.

Accordingly, it would be desirable to provide an interactive television program guide application that allows users to access program guide screens and related features when interactive television program guide application information is not available.

### SUMMARY OF THE INVENTION

In accordance with some aspects of the present invention, an interactive television program guide application is provided that determines approximated information using historical content. For example, the interactive television program guide application may use the historical content or other available information to determine approximated information when information is not available. In some embodiments, information may be retained, stored, or archived as historical content that may be used in making determinations of approximated information.

For example, information may not be available because the information has not yet been provided by the television service provider or because the interactive television program guide application has not yet downloaded the information (e.g., because the interactive television program guide application has not yet scanned through all of the channels on which information is delivered).

When interactive television program guide application information is unavailable, the interactive television program guide application may determine approximated information based on historical content. The approximated information may then be displayed in the interactive television program guide, and the interactive television program guide application may allow the user to access program guide features that would otherwise require the unavailable information.

In some embodiments, the interactive television program guide application may provide the user with an opportunity to select how the interactive television program guide application displays or otherwise indicates approximated information to the user. For example, the interactive television program guide application may display approximated information using different display characteristics, such as, for example, using different fonts, colors, or styles than those used for other information. An icon or other suitable symbol may also be used to indicate approximate information.

In some embodiments, the interactive television program guide application may also provide additional information and features along with the approximated information. The additional information may include, for example, indicators of the certainty of the determination (e.g., 10% certainty, 85% certainty, etc.) and the historical content on which the determination was made. The interactive television program guide application may also also a user to set alerts based on the approximated information or allow the user to edit the approximated information.

One example of approximated information that may be provided by the interactive television program guide application is program listings. For example, the interactive television program guide application may determine an approximated program listing for a particular timeslot based on the program that is aired most frequently at that particular timeslot (e.g., to determine an approximated program listing for channel 2 at 6 PM on Tuesday, the interactive television program guide application may use historical content from that channel and timeslot, from the day before, a week before, two weeks before, or any other suitable time period). As another approach, the interactive television program guide application may determine approximated information using information about television programming schedules, pattern recognition algorithms, or learning algorithms.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with some embodiments of the present invention.

FIG. 2 is a diagram of illustrative user television equipment in accordance with some embodiments of the present invention.

FIG. 3 is a diagram of additional illustrative user television equipment in accordance with some embodiments of the present invention.

FIG. 4 is a diagram of an illustrative remote control in accordance with some embodiments of the present invention.

FIG. 5 is a diagram of illustrative user computer equipment in accordance with some embodiments of the present invention.

FIG. 6 is a generalized diagram of illustrative user equipment in accordance with some embodiments of the present invention.

FIG. 7 is a flowchart illustrative of the basic operation of the interactive television program guide application in accordance with some embodiments the present invention.

FIG. 8 is a flowchart of illustrative steps of one exemplary approach for determining an approximated program listing when the program listing information is unavailable.

FIG. 9A shows an illustrative program listings information screen in accordance with some embodiments of the present invention.

FIG. 9B shows another illustrative program guide screen in accordance with some embodiments of the present invention.

FIG. 10 shows another illustrative program listings information screen in accordance with some embodiments of the present invention.

FIG. 11 shows another illustrative program listings information screen in accordance with some embodiments of the present invention.

FIG. 12 shows another illustrative program listings information screen in accordance with some embodiments of the present invention.

FIG. 13 shows yet another illustrative program listings information screen in accordance with some embodiments of the present invention.

FIG. 14 is an illustrative screen showing how an interactive television application may provide a user with an opportunity to set a program alert in accordance with some embodiments of the present invention.

FIG. 15 is an illustrative display screen showing how an alert may be provided for a user in accordance with some embodiments of the present invention.

FIG. 16 is another illustrative display screen showing how an alert may be provided for a user in accordance with some embodiments of the present invention.

FIG. 17 is an illustrative screen showing how an interactive television application may provide a user with an opportunity to edit a program listing in accordance with some embodiments of the present invention.

FIG. 18 is an illustrative screen showing how an interactive television program guide application may provide a user with an opportunity to view the historical content of a timeslot in accordance with some embodiments of the present invention.

FIG. 19 is another illustrative screen showing how an interactive television program guide application may provide a user with an opportunity to view the historical content of a timeslot in accordance with some embodiments of the present invention.

FIG. 20 is an illustrative display screens showing how a user's scheduled recordings may be presented and selected in an interactive list in accordance with some embodiments of the present invention.

FIG. 21 is an illustrative display screens showing how a user's scheduled recordings may be presented and selected from an interactive list in accordance with some embodiments of the present invention.

### DETAILED DESCRIPTION OF THE PREFERRED EMBODIMENTS

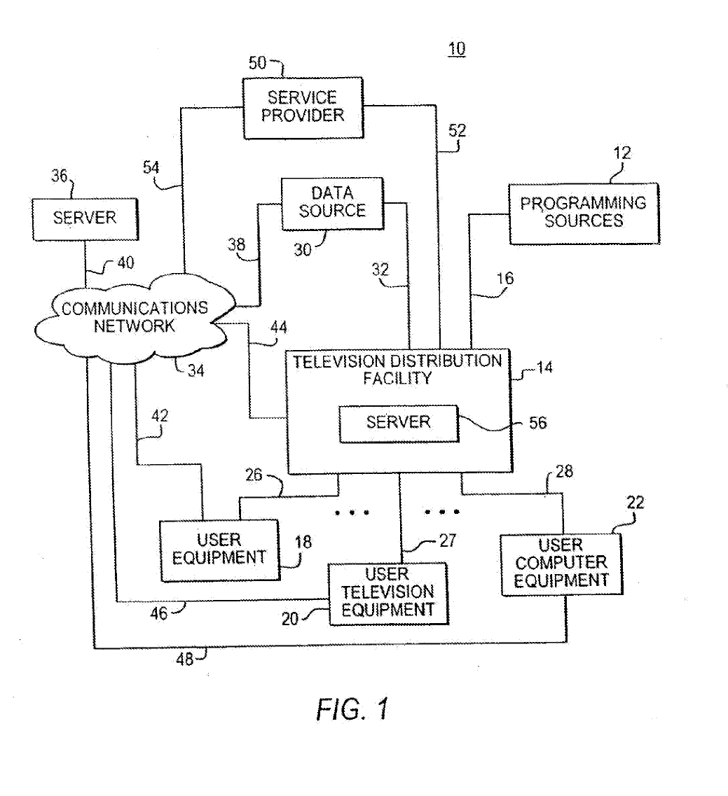

An illustrative interactive television system 10 in accordance with one embodiment of the present invention is shown in FIG. 1. Content such as television programming and other media, such as digital music, may be provided from programming sources 12 to television distribution facilities such as television distribution facility 14 using communications path 16. Programming sources 12 may be any suitable sources of television and music programming, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, or wireless connections for broadcast or satellite links.

Data source 30 may include a program listings database that is used to provide the user equipment with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications), real-time data such as sports scores, stock quotes, news, weather, etc. Although data source 30 is drawn as an individual box in FIG. 1, data source 30 and the other system components of FIG. 1 may be provided using equipment at one or more locations. Systems components are drawn as single boxes in FIG. 1 to avoid over-complicating the drawings.

Data source 30 may provide program schedule information and other data to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

User equipment devices such as user television equipment and personal computers may use the program schedule information to display program listings and information on media, such as, for example, digital music for the user. An interactive television program guide application or other suitable application may be used to display such information on the user's display.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, fiber-optic path, satellite path, a combination of such paths, etc.

User equipment such as user television equipment 20 and user computer equipment 22 may access the on-line program guide and server 36 using similar arrangements. User television equipment 20 may access the on-line program guide and server 36 using communications path 46 or using path 27, television distribution facility 14, and path 44. User computer equipment 22 may access the on-line program guide and server 36 using communications path 48 or using path 28, television distribution facility 14, and path 44. Paths 46 and 48 may be any suitable paths, such as wired paths, cable paths, fiber-optic paths, wireless paths, satellite paths, a combination of such paths, etc.

The data distribution technique that is used to distribute data to user television equipment 20 on either of paths 27 or 46 may depend on the type of information that is being distributed. For example, text and graphics may be distributed over an out-of-band channel using an out-of-band modulator, distributed over a digital in-band channel, or distributed in the vertical blanking interval lines of one of the channels. Video information may also be distributed in this way, although large quantities of video information may be more efficiently distributed using one or more digital channels or streams on path 27 or 46. Such digital channels or streams may also be used for distributing text and graphics.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

If desired, applications such as the interactive television program guide application, a home shopping application, a home banking application, a video-on-demand application, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping, network-based video recorder functions, personal video recorder functions, navigational functions, program guide functions, communications functions, and other suitable functions may be provided using one application or any other suitable number of applications.

Moreover, the interactive television program guide application, the home banking application, the home shopping application, the network-based video recorder and personal video recorder applications, the video-on-demand application, the gaming applications, communications applications, and navigational applications, are only a few illustrative examples of the types of interactive television applications that may be supported by system 10. Other suitable applications that may be supported include, news services, web browsing and other Internet services, and interactive wagering services (e.g., for wagering on horse races and the like).

The interactive television application or applications that are used in interactive television system 10 may be implemented locally on the user equipment. The applications may also be implemented in a distributed fashion (e.g., using a client-server architecture in which the user equipment serves at least partly and for at least some of the time, as the client and a server such as server 56 at television distribution facility 14, server 36, or other suitable equipment acts as the server. Other distributed architectures may also be used if desired. Moreover, some or all of the interactive television system features of system 10 may be provided using operating system software or middleware software. Such operating system software and middleware may be used instead of or in combination with application-level software. Regardless of the particular arrangement used to implement interactive television features related to program guides, home shopping, home banking, video-on-demand, Internet, communications, etc., the software that supports these features may be referred to as an application or applications.

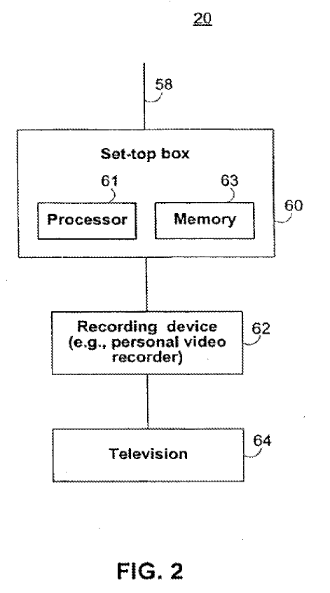

Illustrative user television equipment 20 that is based on a set-top box arrangement is shown in FIG. 2. Input/output 58 may be connected to communications paths such as paths 27 and 46. Input/output functions may be provided by one or more wires or communications paths, but are shown as a single path in FIG. 2 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be handled together if desired. Multiple tuners may be provided (e.g., to handle simultaneous watch and record functions). Box 60 may be an integrated receiver decoder (IRD) that handles satellite television. If desired, box 60 may have circuitry for handling cable, over-the-air broadcast, and satellite content. Box 60 may include a storage device (e.g., a digital storage device such as a hard disk drive) for providing recording capabilities. Set-top box 60 may also be connected to a recording device 62 such as a video cassette recorder, personal video recorder, or other device or devices with storage capabilities.

Set-top box 60 contains a processor 61 (e.g., a microcontroller or microprocessor or the like) that is used to execute software applications. Set-top box 60 may contain memory 63 such as random-access memory for use when executing applications. Nonvolatile memory may also be used (e.g., to launch a boot-up routine and other instructions). Hard disk storage (not shown) in box 60 or in recording device 62 may be used to back up data and to otherwise support larger databases and storage requirements than may be supported using random-access memory approaches.

Set-top box 60 may have infrared (IR) or other communications circuitry (not shown) for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a telephone modem, wireless modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 2 and the other equipment of system 10, the audio associated with various video items is typically distributed with those video items and is generally played back to the user as the videos are played.

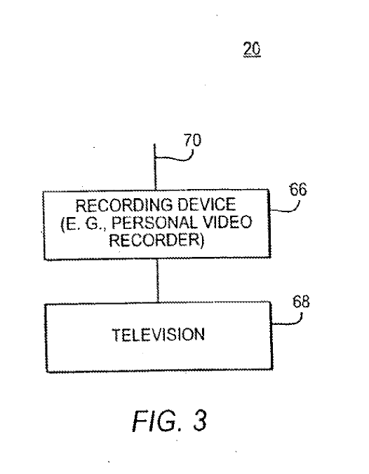

Another illustrative arrangement for user television equipment 20 is shown in FIG. 3. In the example of FIG. 3, user television equipment 20 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. Equipment 20 of FIG. 3 may also include a television 68. Input/output 70 may be connected to communications paths such as paths 27 and 46. Television programming and other information may be received using input/output 70. Commands and requests and other information from the user may be transmitted over input/output 70.

Recording device 66 may contain at least one analog tuner for tuning to a desired analog television channel (e.g., multiple tuners may be provided). Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 3 or recording device 62 of FIG. 2 may record new video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

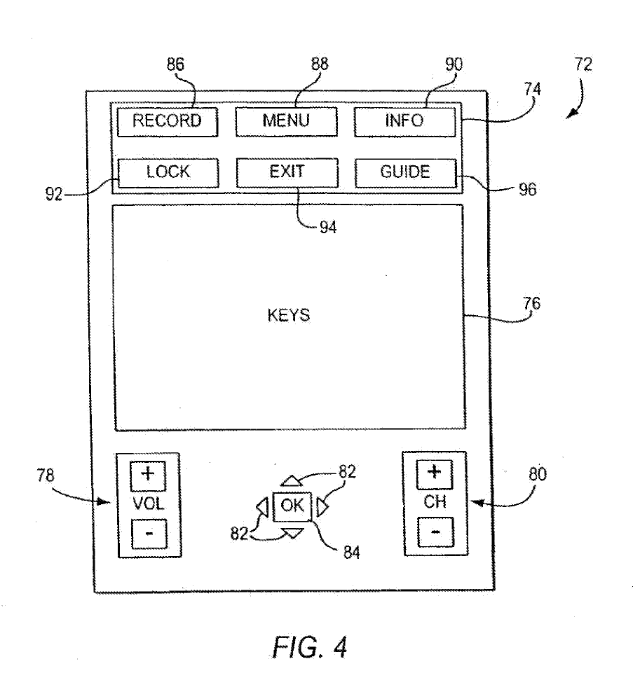

An illustrative remote control 72 for operating user television equipment 20 (or suitable user computer equipment 22) is shown in FIG. 4. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television application to display a menu on the user's display screen (e.g., on television 64 or 68 or on a suitable monitor or computer display). Info button 90 may be used to direct the interactive television application to display an information display screen. If the user has highlighted a particular program listing, for example, pressing the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the interactive television application or to exit a portion of the interactive television application. Guide button 96 may be used to invoke the interactive television program guide.

The keys shown in FIG. 4 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

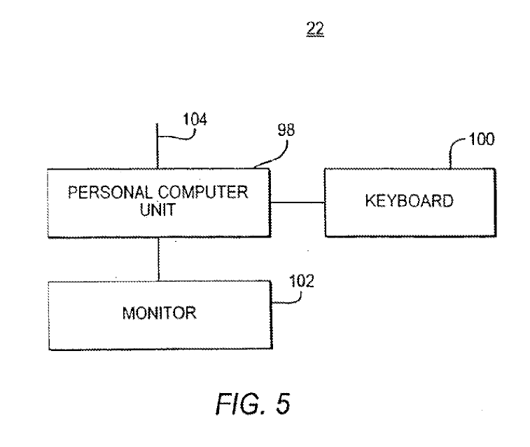

Illustrative user computer equipment 22 is shown in FIG. 5. In the arrangement of FIG. 5, personal computer 98 may be controlled by the user using keyboard 100 or other suitable user input device, such as a trackball, mouse, touch pad, touch screen, voice recognition system, a remote control such as remote control 72 of FIG. 4, etc. Video content such as television programming and interactive television application display screens may be displayed on monitor 102. Television programming, video-on-demand content, video recordings played back from a network-based video recorder, and other information may be received from paths 28 and 48 (FIG. 1) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Storage in personal computer unit 98 such as a hard drive, DVD drive, CD drive, or other suitable storage device or devices may be used to store video and other content. For example, the interactive television application and personal computer unit 98 may use this storage to provide the functions of a personal video recorder.

User equipment 18 such as user television equipment 20 and user computer equipment 22 may be used with network equipment such as server 56, server 36, and equipment at service providers such as service provider 50 of FIG. 1 to provide network-based video recording functions. Video recording functions may be provided by storing copies of television programs and other video content on a remote server (e.g., server 56 or server 36 of FIG. 1) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 1. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

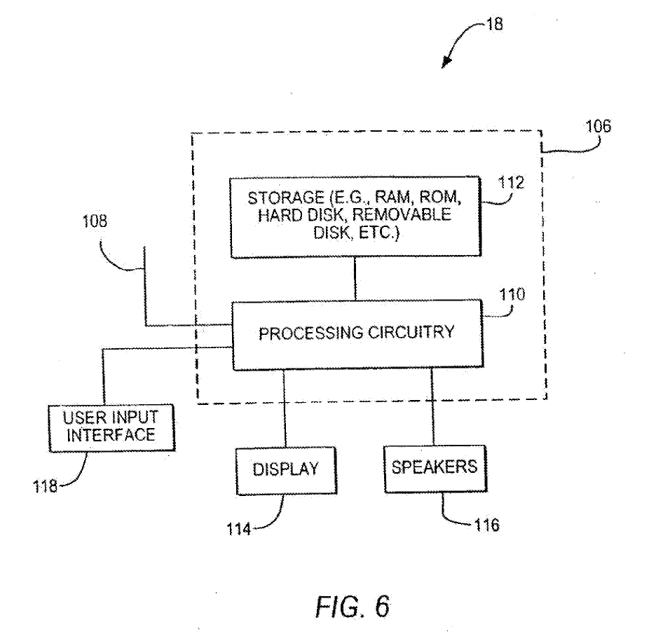

The user television equipment and user computer equipment arrangements described above are merely illustrative. A more generalized embodiment of illustrative user equipment is shown in FIG. 6.

As shown in FIG. 6, control circuitry 106 is connected to input/output 108. Input/output 108 may be connected to one or more communications paths such as paths 26, 27, 28, 42, 46, and 48 of FIG. 1. Television and music programming may be received via input/output 108 (e.g., from programming sources 12, servers or other equipment such as server 36, service providers such as service provider 50, and television distribution facility 14). Program schedule information for an interactive television program guide may be received from data source 30 via input/output 108. Input/output 108 may also be used to receive information from data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 112 that is part of control circuitry 106. Tuning circuitry such as one or more analog tuners, one or more MPEG-2 decoders or other digital video circuitry, or any other suitable tuning or video circuits or combinations of such circuits may also be included as part of circuitry 106. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

A user may control the control circuitry 106 using user input interface 118. The user input interface 118 may be any suitable user interface, such as a mouse, trackball, keypad, keyboard, touch screen, touch pad, voice recognition interface, remote control, etc.

Referring back to FIG. 1, interactive television program guide application information, such as program listings information, may be provided by data source 30 to television distribution facility 14 for distribution to associated user equipment or may be provided by the data source 30 to server 36 which may be accessed by the user equipment. During operation, a user may access guide functions for which program guide information is unavailable or was not accessed by the user equipment. For example, at a given point in time only the information about the program listings for the next week of programming may be available.

In some embodiments of the present invention, the interactive television program guide application may provide the user with approximated information when program guide information is unavailable. For example, the interactive television program guide application may provide the user with an opportunity to browse through approximated program listings when program listings are not available. The approximated program listings may inform the user of the program or programs determined to have the greatest likelihood of being shown at a given time. The interactive television program guide application may also provide the user with additional information associated with the approximated information, such as, for example, approximated program durations, approximated program descriptions, and approximated program ratings.

Although the interactive television program guide application is primarily described herein as determining approximated program listings, it should be understood that the interactive television program guide application may determine approximated information for any interactive television program guide application information that is not available. For example, the interactive television program guide application information may be approximated for program information, pay-per-view services, video-on-demand services, web-browsing services, games, home shopping, and other program guide features. The discussion of the determination of approximated program listings is merely illustrative of a single embodiment of this invention.

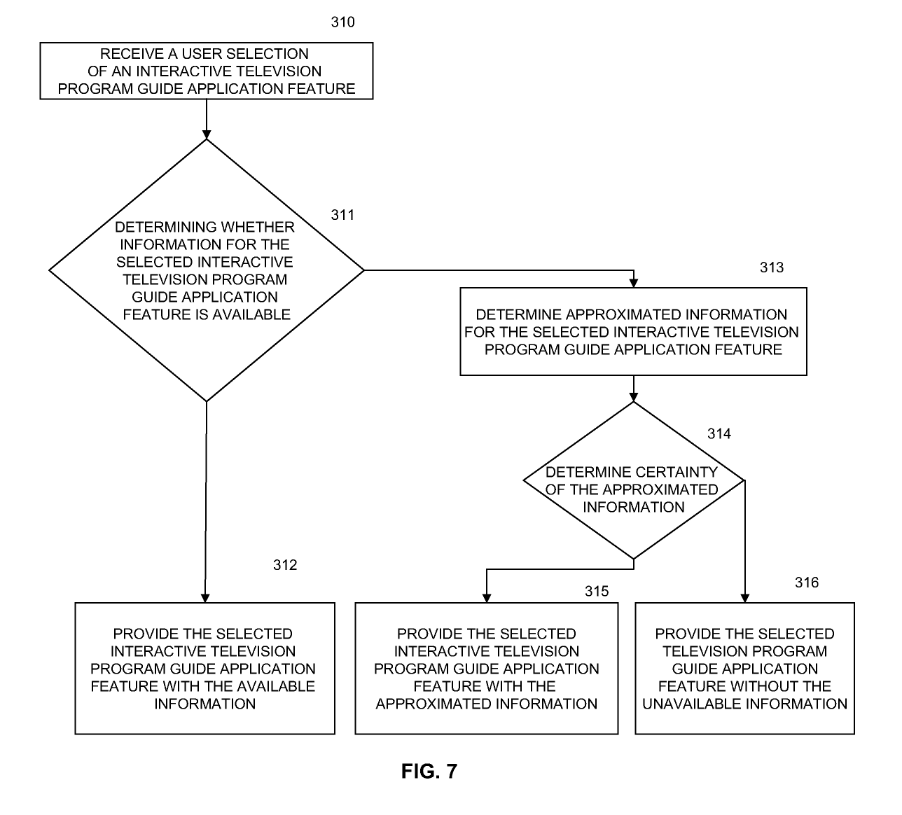

FIG. 7 is a flowchart of illustrative steps involved in providing a user with approximated information, such as, approximated program listings information. At step 310 of FIG. 7, the interactive television program guide application receives a user selection of an interactive television program guide application feature. For example, the user may invoke a television program guide to view the program listing for a particular program, for all programs broadcast at the current time and date, or for all programs broadcast at a future time and date. The television program guide may be displayed, for example, on display 114 (FIG. 6) when the user presses an appropriate remote control button such as guide button 96 (FIG. 4) or otherwise uses user input interface 118 (FIG. 6) to indicate a desire to view program listings. At step 311, the interactive television program guide application determines whether all of the information that is needed to display the interactive television program guide application feature is currently available. For example, the interactive television program guide application running on processing circuitry 110 (FIG. 6) may access the information from storage 112 (FIG. 6) of user equipment 18 (FIG. 1) or from information provided by data source 30 (FIG. 1) to television distribution facility 14 (FIG. 1) for distribution to associated user equipment or provided by the data source 30 to server 56 which may be accessed by the user equipment. If the interactive television program guide application determines that all of the information is currently available (e.g., has been provided, downloaded, or can be accessed), at step 312, the interactive television program guide application may display the selected interactive television program guide application feature with the information. If the interactive television program guide application determines that all of the information is not available, at step 313, the interactive television program guide application may determine approximated information using historical content. Alternatively, the interactive television program guide may determine approximated information using historical content independent of the selections of an interactive television program guide application feature (e.g., approximated information may be determined at start up of the interactive television program guide application or at periodic intervals that may be unrelated to user actions). According to this embodiment, the determined approximated information may be accessed at step 313.

At step 314, in response to determining or accessing the approximated information, the interactive television program guide application may determine the certainly of the approximated information. The certainty of the determination of the approximated information may be determined based at least partially on such factors as the amount of historical content available, the uniformity or consistency of the historical content, the type of information that is determined, and the amount of time elapsed between the historical content and the determined approximated information. For example, when determining approximated television program listings, if nine out of the ten available program listings for a particular timeslot are for “SEINFELD,” the program “SEINFELD” is determined to be the approximated program listing for that timeslot with a relatively high degree of certainty. However, if five of the available program listings for a particular timeslot are for “SEINFELD” and four of the available program listings at the timeslot are for “FRIENDS,” the approximated program listing for that timeslot may be determined to a relatively low degree of certainty. The interactive television program guide application may also determine that the approximated information cannot be determined to a sufficient degree of certainty to provide approximated information. The level of certainty that is sufficient may be chosen by the interactive television application or may be at least partially configured by the user.

If the interactive television program guide application determines the approximated information to a sufficient degree of certainty, at step 315 the interactive television program guide application may display the interactive television program guide application feature with the approximated information. It should be noted that the approximated information may be displayed in a different manner than the available information. If, however, the interactive television program guide application could not determine the approximated information to a sufficient degree of certainty, at step 316 the interactive television program guide application may display the selected interactive television program guide application feature without the unavailable information. In some embodiments, the interactive television program guide application may be unable to display the selected interactive television program guide application feature without the unavailable information and may indicate that the feature cannot be displayed.

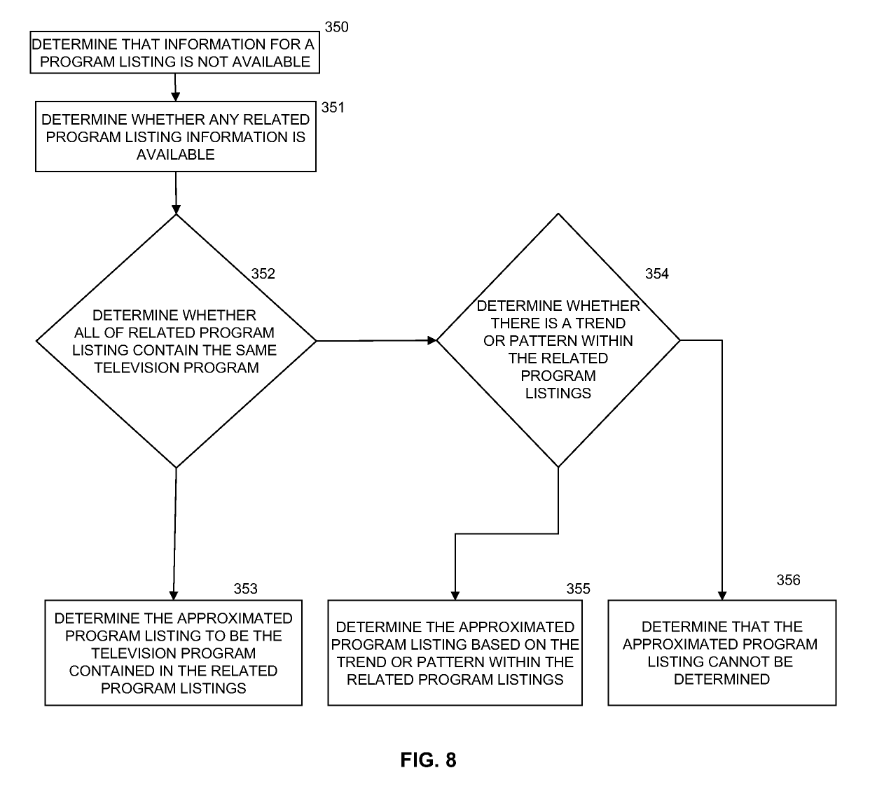

FIG. 8 is a flowchart of illustrative steps of one exemplary approach for determining an approximated program listing when the program listing information is not available. According to this approach, the interactive television program guide application may determine approximated program listings information using information available from related television listings. At step 350 the interactive television program guide application may determine that information for a program listing is not available. In response to determining that the program listing information is unavailable, at step 351 the interactive television program guide application may determine if any related program listings information is available, such as, for example, program listings from previous weeks from the same timeslot as the unavailable program listing.

At step 352, if the interactive television program guide application determines that all of the related program listings contain the same television program, at step 353 the unavailable program listing may be determined to be the television program contained in the related program listings. If all of the related program listings do not contain the same television programs, at step 354 the interactive television program guide application may determine if there is a trend or pattern within the related program listings. The trend or pattern within the related program listings may include for example the most frequently broadcast television program or the most recently broadcast television program. If the interactive television program guide application determines that there is a trend or pattern, at step 354 the interactive television program guide application may determine the unavailable program listing based on the trend or pattern at step 355. If all of the related program listings do not contain the same television programs and if the interactive television program guide application does not identify a trend or pattern within the television programs of the related program listings, at step 356 the interactive television application may determine that the unavailable program listing cannot be determined.

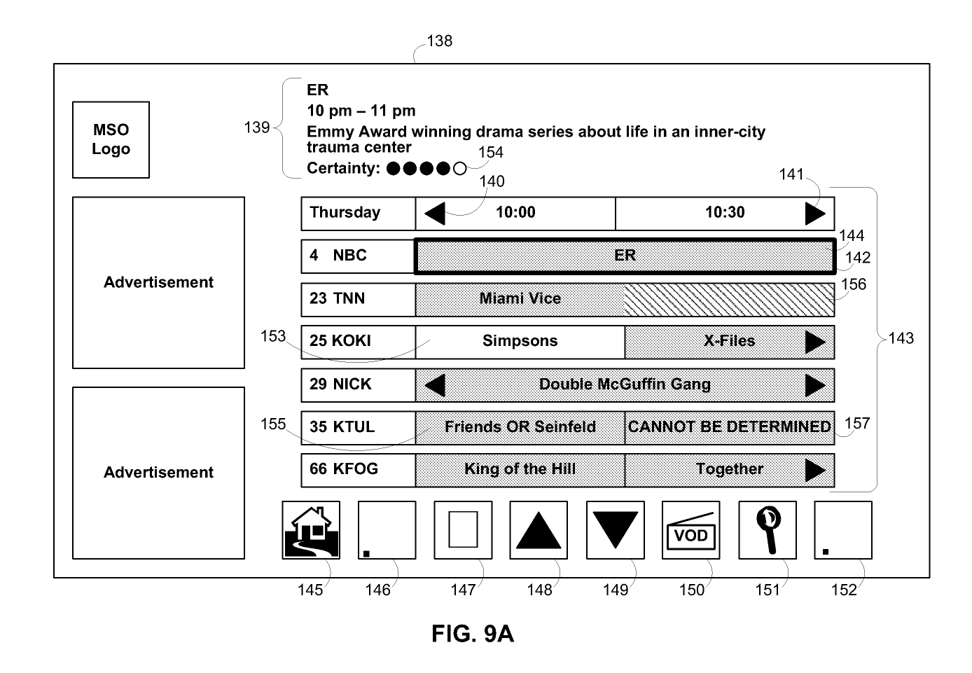

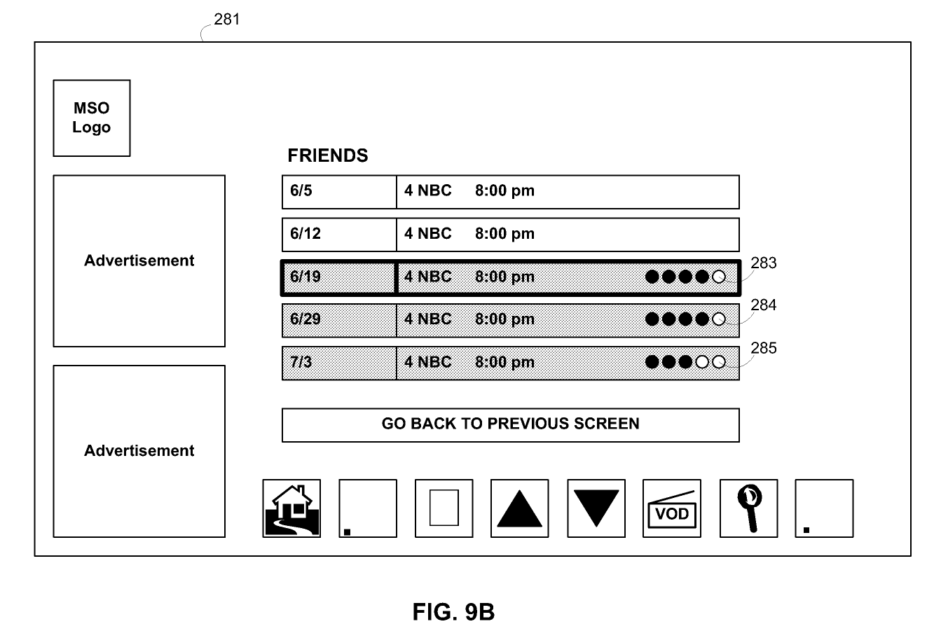

FIGS. 9A-22 show illustrative program guide screens having approximated information that may be provided by the interactive television application in accordance with some embodiments of the present invention. Although FIGS. 9A-22 show illustrative program guide screens that may be provided to the user, other program guide screens for an interactive television program guide application are also described in, for example, U.S. patent application Ser. No. 10/306,175, filed Nov. 25, 2002, which is hereby incorporated herein in its entirety.

An illustrative program guide listings information screen 138 that may be displayed for the user is shown in FIG. 9A. Program guide screen 138 may be displayed, for example, when the user selects a program listings option, when the user selects a suitable option from within an interactive television program guide application or other interactive television application, or when the user presses an appropriate remote control button such as guide button 96 (FIG. 4) or otherwise uses user input interface 118 (FIG. 6) to indicate a desire to view program listings.

Program guide screen 138 may contain a grid or list of program listings 143. Program listings 143 may include program titles, channels, scheduled broadcast times, and any other suitable program schedule information. Highlight region 142 may be used to select a desired program listing 144. Program information for selected programs may appear elsewhere on program guide screen 138 (e.g., in program information display region 139). If the user presses OK key 84 (FIG. 4) when a program listing for a current program is highlighted, the interactive television program guide application may tune to the channel for that program. If the user presses OK key 84 when a program listing for a future program is highlighted, the interactive television program guide application may provide the user with an opportunity to set an alert or reminder for that program or to record that program.

Other functions that the interactive television program guide application may provide include the ability to set favorites or establish preferences or other settings. For example, the user may select a particular channel for the program guide to automatically tune to when the user equipment is turned on. The user may also select favorite programs, favorite channels, etc. The program guide or other interactive television application may provide the user with the ability to establish parental control settings, the ability to search for programming of interest, and the ability to view program descriptions, advertisements, text, graphics, and video, etc. These are merely illustrative functions that may be provided by interactive television system 10 (FIG. 1). Other suitable interactive television functions may be provided if desired.

As shown in FIG. 9A, program listings 143 are currently being displayed for television programs that are being broadcast between 10:00 PM and 11:00 PM. As shown by arrows 140 and 141, the user may use left or right cursor keys to navigate to program listings at different times (e.g., to direct the interactive television application to display appropriate screens of program listings 143 for different time periods). If desired, the user may select options or press keys (or use user input interface 118 to otherwise enter suitable commands) that direct the interactive television program guide application to display program listings organized by channel, by genre, by service type (e.g., pay-per-view or regular broadcast television), etc.

Selectable options, such as options 145-152, may be provided as part of program guide screen 138 or any other program guide screen for providing access to various interactive television application features. For example, option 145 may be used to display a home screen or main menu. Option 146 may be selected to display program listings for channels designated by the user as “favorites.” Option 147 may be selected to display listings of recommended programs using highlight region 142. Scroll indicators 148 and 149 may be used to navigate down and up through program listings. Option 150 may be selected to display information related to video-on-demand services.

Option 151 may be selected to search television program listings by title, time, category, or any other suitable criteria. Option 152 may be selected to display information related to digital music services. The options shown in FIG. 9A are merely illustrative. Other suitable options may be provided, if desired.

In some embodiments, approximated program listings based on approximated information may be presented to the user in a different manner than listings based on available information. For example, the interactive television program guide application may alter the appearance of approximated program listings by using a different color, shade, and/or font, or by including a special icon.

In some embodiments, the interactive television program guide application may also provide other information along with the approximated program listings. For example, an approximated program listing may include indicators of the certainty of the determination (e.g., a high level of certainty, 80% certainty, a low level of certainty, 10% certainty, etc.). In FIG. 9A, program listing 153 is based on available program information, while the other program listings are approximated program listings based on approximated information that was determined by the interactive television program guide application.

The interactive television program guide application may display these indicators in any suitable location on program guide screen 138, such as, for example, in program information display region 139. In another suitable approach, such content may be provided in a pop-up window. In the approximated programs listings, some program information may be absent or replaced by general program information and/or information about the determination of the approximated information. For example, information corresponding to the television series of the approximated television program listing may be shown instead of information corresponding to a particular television episode.

As shown in FIG. 9A, the interactive television program guide application may provide the user with a certainty indicator 154. For an approximated program listing, indicator 154 may provide the user with an indication of the certainty of the determination of the approximated information. For example, an approximated program listing that is determined to a high level of certainty may have an associated certainty indicator that indicates such a high level of certainty (e.g., four out of five pips, a high percentage, etc.), while an approximated program listing that is determined to a lower level of certainty would have a certainty indicator which would indicate such a lower level of certainty (e.g., two out of five pips). In some embodiments, the indicator may be a visual graph (as shown in FIG. 9A). However, any other suitable indicator may be used, such as, a numerical percentage, a color code, a check mark, etc.

The interactive television program guide application may provide different types of approximated program listings. For example, approximated program listing 155 contains “FRIENDS OR SEINFELD,” instead of a single program listing. According to this example, the interactive television program guide application has determined that there is a sufficient certainty that either the program “FRIENDS” or the program “SEINFELD” might be shown in that given timeslot. Program listing 156 is another example of a type of approximated program listing. In program listing 156, half of program listing is displayed differently than the other half. This may indicate to the user that the duration of the program has not been determined to a sufficient certainty and that the program or programs determined as likely to air at that particular timeslot may be of an undeterminable or uncertain length. In response to the interactive television program guide application being unable to determine or predict program information for a particular timeslot, to a sufficient certainty, the program listing, such as program listing 157 may be “CANNOT BE DETERMINED”.

The level of certainty that is sufficient to determine approximated information for an approximated program listing may be predetermined by the interactive television program guide application or may be user configurable. In some embodiments, a user may configure the interactive television program guide application to require high degrees of certainty. For example, the user may direct the interactive television program guide application to only display an approximated program listing when the degree of certainty is greater than 80%. This may result in the interactive television program guide application displaying approximated program listings that are more accurate. This may also result in the a greater number of approximated program listings that contain multiple program options, multiple duration options, and approximated program listings that “CANNOT BE DETERMINED.”

In another example, a user may direct the interactive television program guide to require a lower degree of certainty, which may result in approximated program guide listings that are less accurate, but fewer listings that “CANNOT BE DETERMINED”. The examples above are merely illustrative of different types of approximated program listings that may be provided by the interactive television program guide application in accordance with the present invention.

Another suitable display arrangement for providing approximated program listings is shown in FIG. 9B. In this embodiment, program listings for a particular program are shown sorted by broadcast date. Screen 281 shows an illustrative listing for the television program “FRIENDS.” In FIG. 9B, the program listings are available for the first two broadcasts of the program “FRIENDS,” but the following three broadcasts of the program “FRIENDS” are approximated program listings determined using historical content (e.g., program guide history for this program or timeslot.) The certainty indicators 283, 284, and 285 for the approximated listings may be lower the further the approximated listing is in future.

If the user selects a program listing for a currently broadcast television program (e.g., by pressing OK key 84 when a program listing for a currently broadcast program is highlighted), the interactive television program guide application may tune to the channel for that program. If the user selects a program listing for a future television program, the interactive television program guide application may provide the user with an opportunity to set a reminder for that program or to record that program. If the program listing is an approximated program listing, the interactive television program guide application may provide the user with an opportunity to set an alert for that timeslot, to set a reminder for that program, or to record that program. The interactive television program guide application may also provide the user with additional information associated with the approximated program listing and the details associated with its determination.

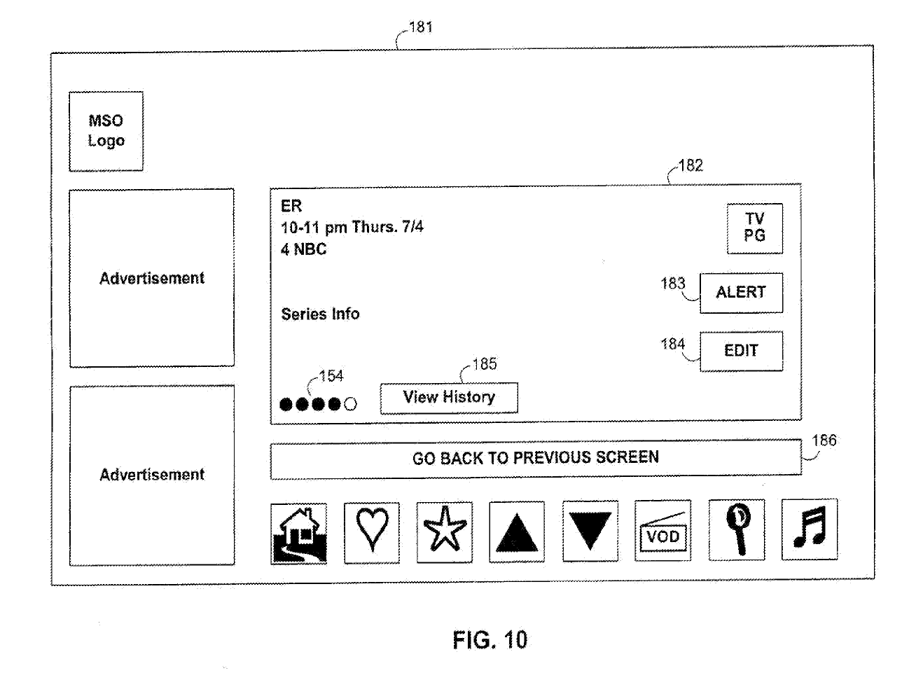

For example, selecting an approximated program listing, may display program guide screen 181 shown in FIG. 10. Program guide screen 181 contains program information box 182, which may show available and approximated information (e.g., title, time, channel, and rating of the program), a certainty indicator 154, an alert button 183, an edit button 184, a view history button 185, and a button 186 that when selected, directs the interactive television program guide application to return to the previously viewed screen.

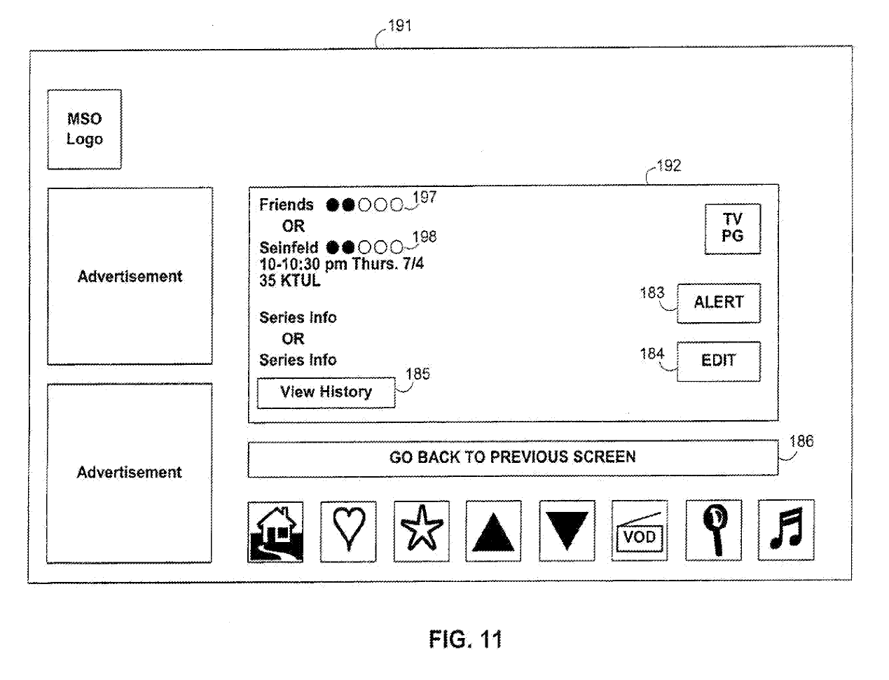

FIGS. 11-13 show additional illustrative program listing information screens having approximated information that may be provided to the user by the interactive television program guide application. FIG. 11 may be displayed in response to the user selecting, for example, approximated program listing 155 of FIG. 9A. Program information window 192 shows an approximated program listing having two television programs that the interactive television program guide application determined as likely to be shown during this particular timeslot. Program information window 192 may provide information relating to both programs, certainty indicators 197 and 198 for each program, an alert button 183, an edit button 184, a history button 185, and a button 186 to return to interactive television program guide application to the previous screen.

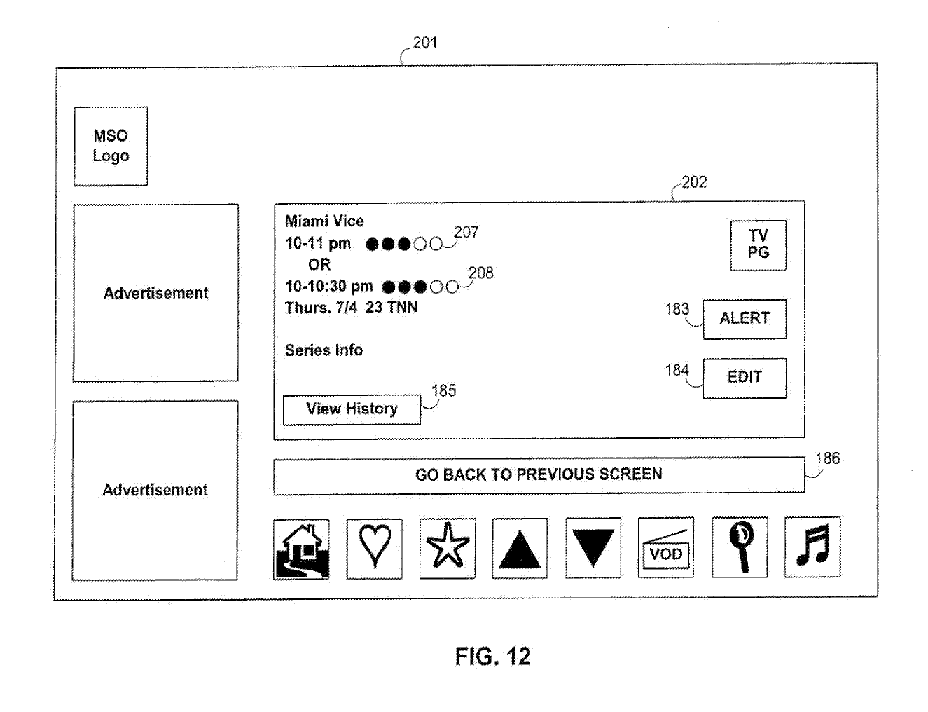

Referring back to FIG. 9A, in response to the user selecting program listing 156, the interactive television program guide application may provide the user with, for example, FIG. 12. The interactive television program guide application may provide the user with a program information window 202 that shows the approximated program listing and associated approximated information. Program information window 202 also shows the two possible durations that the interactive television program guide application has determined to be likely for the approximated program listing. Program information window 202, may also contain information about the program, certainty indicators 207 and 208 for each duration, an alert button 183, an edit button 184, a history button 185, and a button 186 to return to interactive television program guide application to the previous screen.

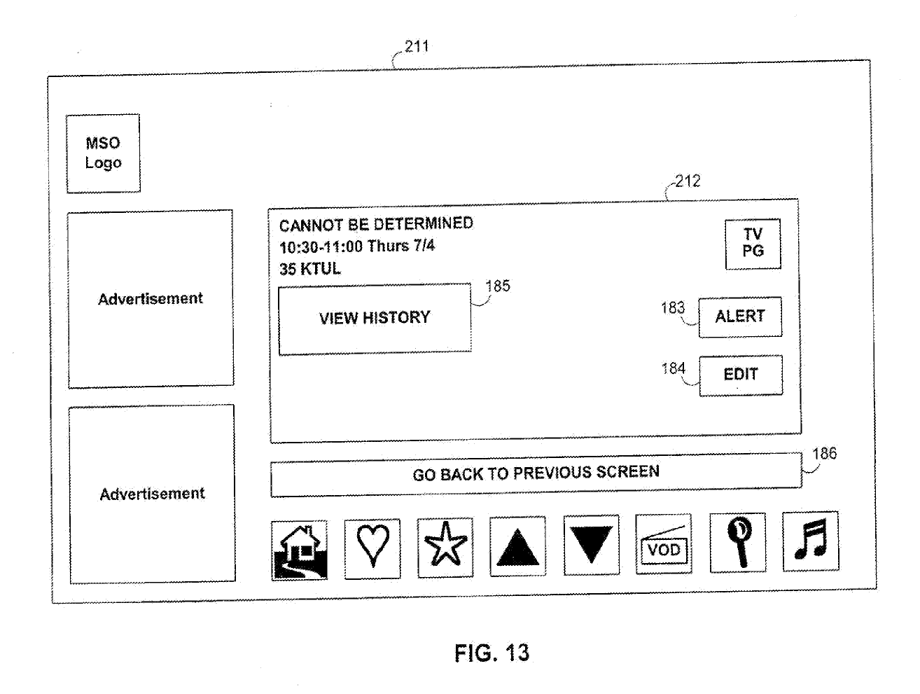

Referring back to FIG. 9A, in response to the user selecting program listing 157, the interactive television program guide application may provide the user with, for example, FIG. 13. The interactive television program guide application may provide the user with a program information window 212. Program information window 212 shows that approximated information for the timeslot cannot be determined. Program information window 212, may also contain information relating to why the determination was not successful, an alert button 183, an edit button 184, a view history button 185, and a button 186 to return the interactive television program guide application to the previous screen.

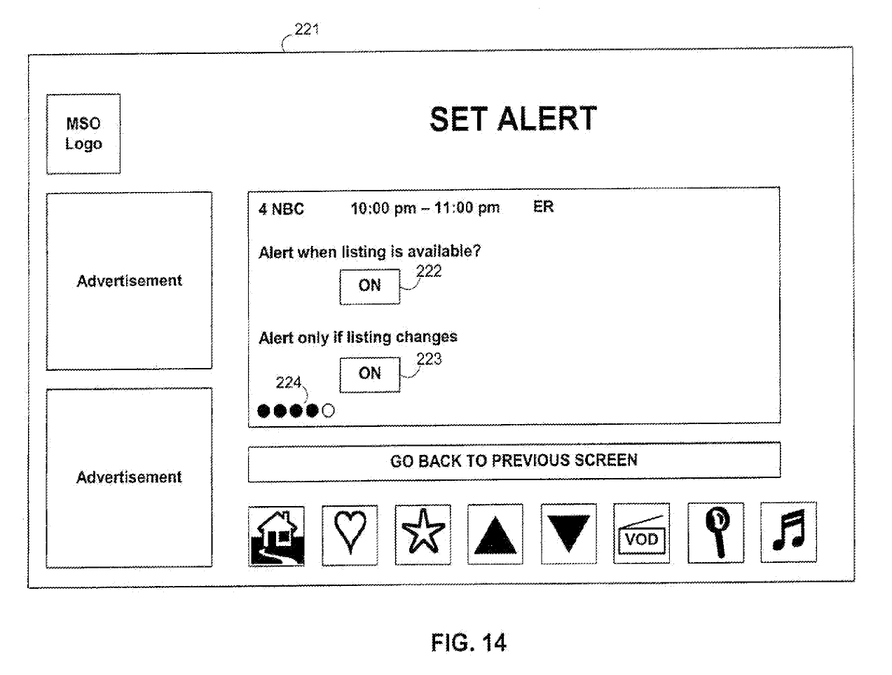

In response to the user selecting an alert button, such as, alert button 183 (FIGS. 10-14), the interactive television program guide application may provide the user with an opportunity to set an alert for the selected approximated program listing. FIG. 14 shows an illustrative program guide screen 221 that allows a user to set an alert. The alert may notify the user when information is available for an approximated program listing. Alternatively, the alert may also be configured to notify the user if the approximated information is modified or updated. Alerts may be set automatically in response to certain user actions, such as, for example, when the user schedules a reminder or a recording for a program having an approximated program listing.

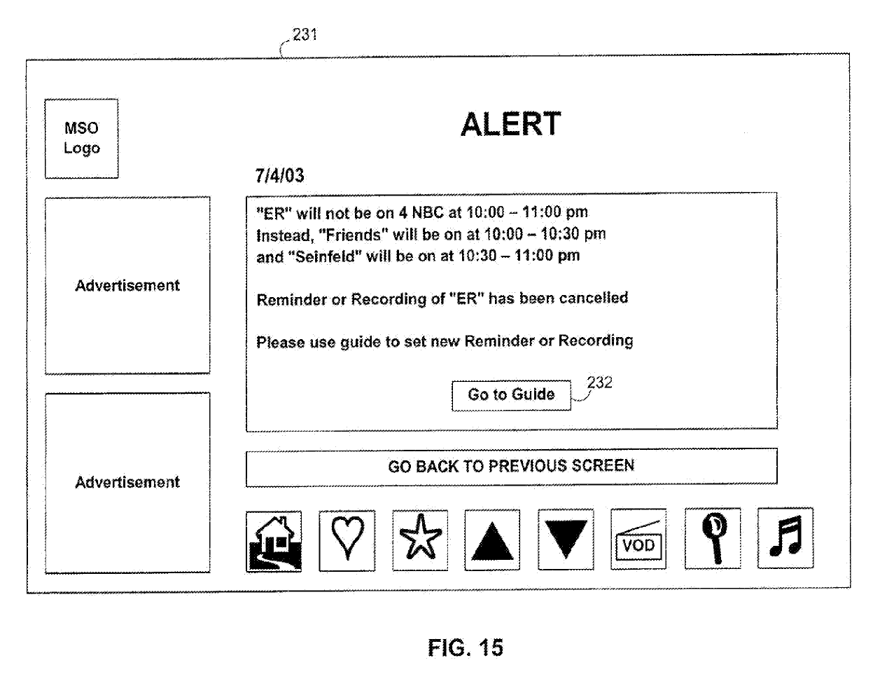

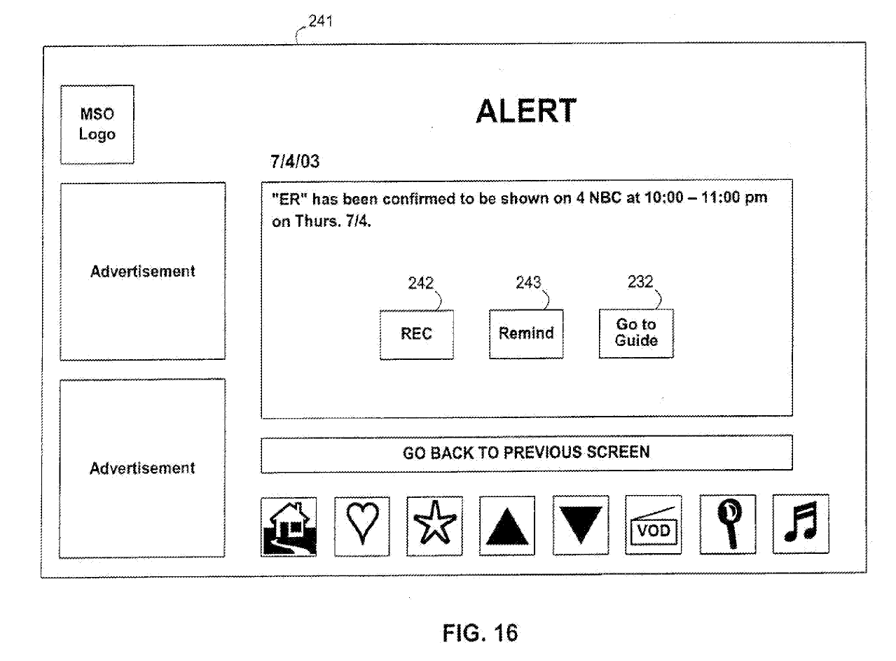

FIGS. 15 and 16 show illustrative program guide screens that may be displayed by the interactive television program guide applications in response to an alert. FIG. 15, shows a screen 231, having an alert, which informs the user that an approximated information is incorrect. In this example, the information received by the interactive television program guide application indicates that the program “ER” will not be shown as determined in the approximated program listing. This alert informs the user that information for this timeslot is presently available and provides the user with the option to view the updated program listings and modify scheduled reminders or recordings. The alert may automatically cancel any reminders or recordings associated with the incorrect approximated information. FIG. 16 shows an illustrative alert screen 241 that confirms the determination of an approximated program listing. The alert screen may provide the option of recording the program 242 or setting a reminder for the program 243.

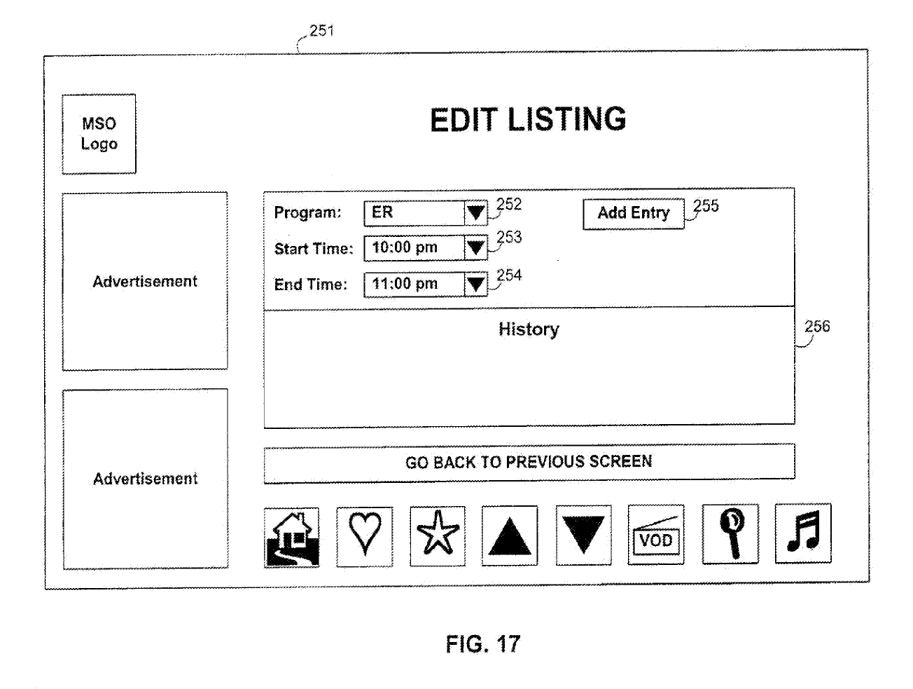

In response to the user selecting an edit button, such as edit button 184 (FIG. 10-13), the interactive television program guide application may provide the user with an opportunity to edit to the selected approximated program listing. An illustrative approximated program listing editing screen 251 is shown in FIG. 17. Screen 251 may provide the user with the ability to edit the approximated program listings if the user disagrees with or wants to modify the approximated information determined by the interactive television program guide application. The user may select buttons 252, 253, or 254, to select a program, start time, or end time, respectively, for the entry being edited. In response to the user selection button 252, the interactive television program guide application may provide, for example, an alphabetical listing of all program titles contained in the historical content or a listing of all the programs determined possible programs for this timeslot. If these program choices do not contain the program desired by the user, an add entry button 255 may be selected that provides the user with an opportunity to enter the desired program name. The desired program name may entered, for example, by selecting the program from a comprehensive list, or by inputting the title using a keypad or any other selectable interface. Screen 251 may also contain a screen portion 256 which would display the program history of that timeslot to assist the user in selecting the correct listing for that timeslot.

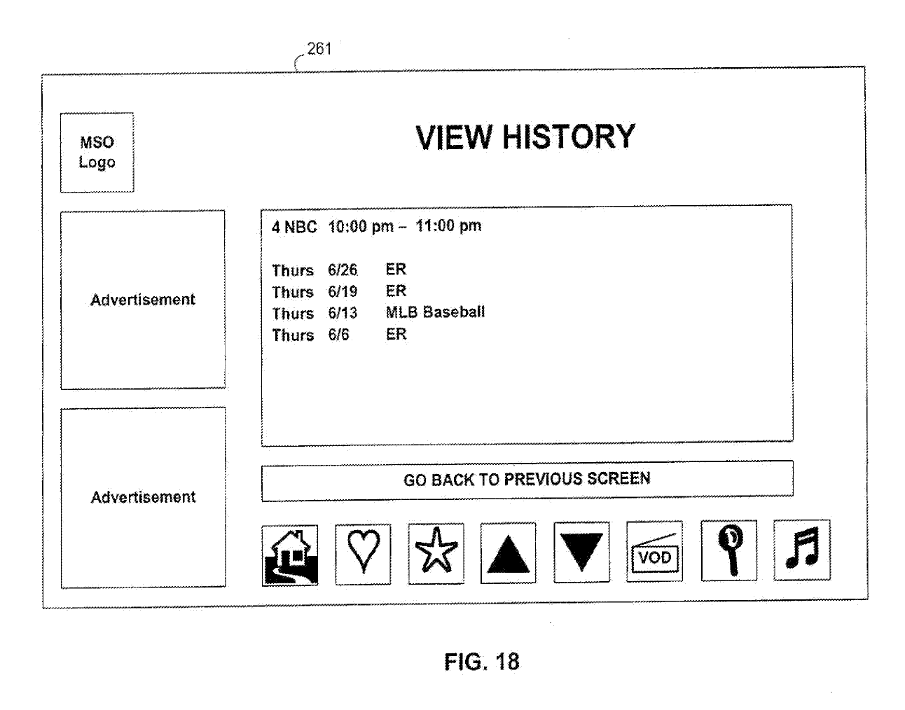

The interactive television program guide application may provide the user with the historical content of a particular timeslot by viewing screen portion 256 of a edit listing screen or by selecting a history button, such as button 185 (FIGS. 10-13). Program guide screen 261 in FIG. 18, is an illustrative view history screen that may be provided to the user by the interactive television program guide application. View history screen 261 displays, for a particular channel and timeslot, a listing of all of the programs broadcast in that timeslot over a certain time period. The time period for which the program history is displayed, such as, for example, four weeks or twelve weeks, may be set by the interactive television program guide application or it may vary based a variety of factors. For example, the period of time for which program history information is provided may depend on the particular timeslot and whether it is a primetime timeslot, a weekday timeslot, or a weekend timeslot, user preference, or constraints of the user equipment, such as memory limitations. View history screen 261 may also provide additional information about each program such as, whether it was new or not, episode information, or ratings information.

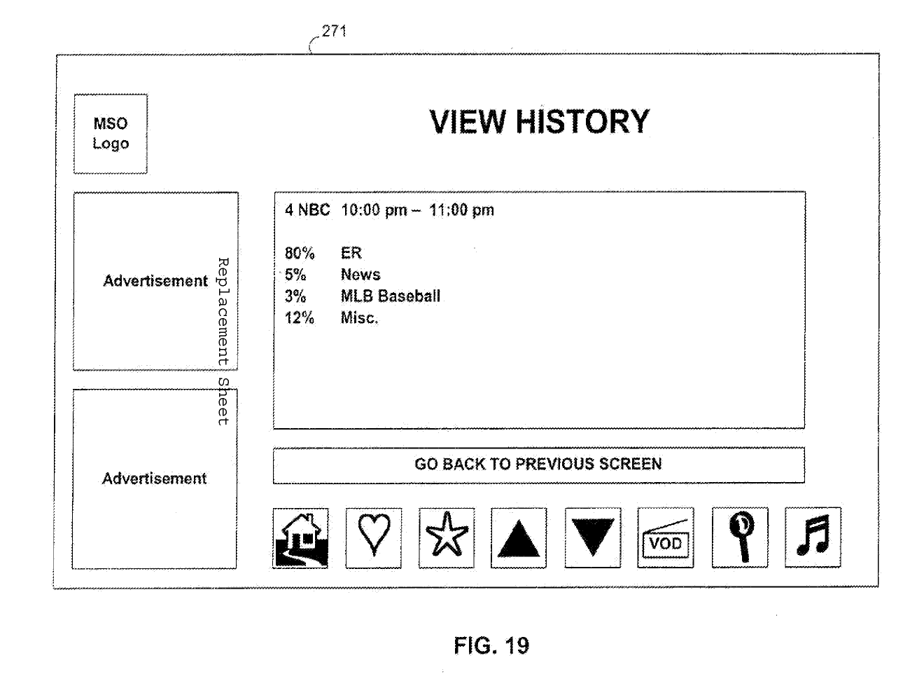

FIG. 19 shows an illustrative view history screen 271 that may be displayed to the user by the interactive television program guide application. Instead of, or in addition to, display screen 261 of FIG. 18, which contains a list of the program listing history for a particular timeslot, view history screen 271 may provide statistical information about a particular channel and timeslot based on the historical content. The statistical information may include, for example, the probability that a particular show is broadcast in the timeslot, the variation of programming broadcast in the timeslot, the probability that a new episode of the program will be broadcast, or any other suitable statistical data that interactive television program guide application may calculate from the historical content.

Interactive television system 10 may be used to support video recorder functions. Once a program has been selected by a user for recording, the selected program may be presented in a list of programs scheduled to be recorded. Television programs may also be automatically selected for recording by the interactive television program guide application. For example, the user may set the interactive television program guide application to record a particular television program or television series every time it is broadcast. As another example, the interactive television program guide application may automatically schedule a recording for a program if a previously scheduled recording of that program was not completed successfully. The interactive television program guide application may automatically schedule recordings for these programs whenever the program listings information indicates that these programs are scheduled to be broadcast. The interactive television program guide application may only automatically schedule recordings based on available program information to avoid automatically scheduling a recording in error. Alternatively, the interactive television program guide application may only automatically schedule recordings based on approximated information that has been determined to a certain degree of certainty or that is not too far in the future. In some embodiments, these options may be configurable by the user. Further, the interactive television program guide application may only proceed to actually record a program if the program information becomes available before the scheduled recording time.

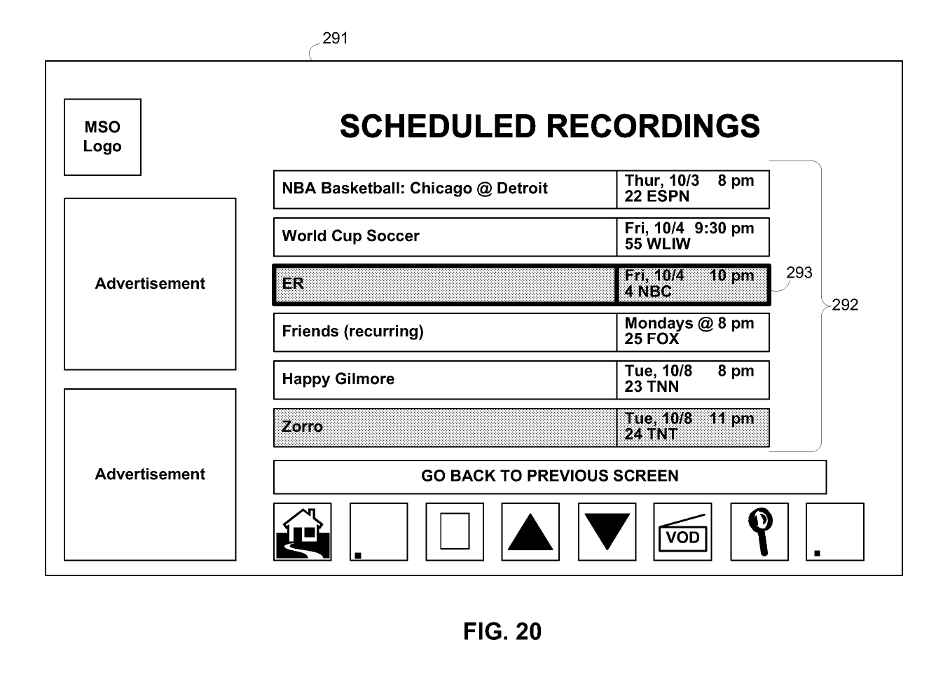

An illustrative scheduled recordings screen 291 that may be displayed to the user is shown in FIG. 20. Screen 291 may include, for example, a list of programs scheduled to be recorded 292. As with the other program guide screens, approximated program information may appear differently from available program information. Screen 291 may also include a highlight region 293 that may be used to select a scheduled recording from the list.

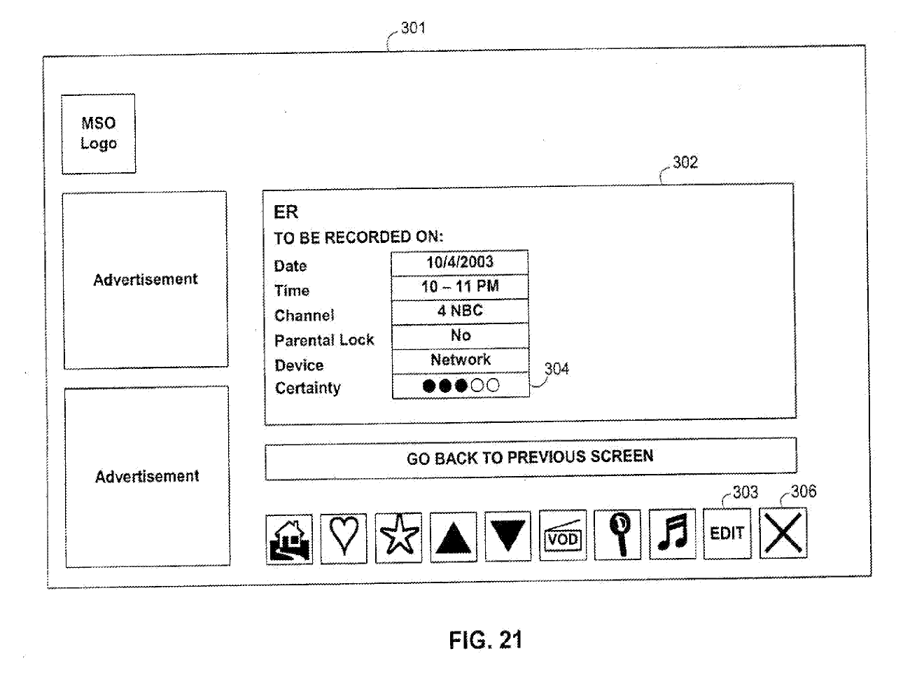

Information about scheduled recordings selected by the user may be presented in an illustrative recording information screen, such as screen 301 of FIG. 21. Screen 301 may include scheduled recording information 302, which may show the date, time, and channel for which a program is to be recorded. Information 302 may also indicate which of the user's devices has been designated to record the program and whether a parental lock has been set for the program scheduled to be recorded. The user may edit information 302 by selecting edit option 303 using a highlight region. For a recording that is scheduled based on an approximated program listing, a certainty indicator 304 may also be provided. The interactive television program guide application may also provide the user with an alert that is automatically set to alert the user if the approximated information is modified, updated, or discovered to be incorrect. Any other suitable selectable options may also be provided in screen 301, such as, for example, cancel option 306 which the user may select to cancel the scheduled recording.

According to some embodiments of the present invention, additional algorithms or techniques may be used by the interactive television program guide application to determine approximated program listings information. For example, the interactive television program guide application may use heuristic or statistical information about television scheduling techniques to determine approximated program listings. According to one such example, the algorithm for determining approximated program listings may differ depending on whether a timeslot to be determined is on a holiday, a weekday, or a weekend, and depending on the time of the day. Such information may be significant, for example, because weekday television schedules may generally be the same every weekday (except during “primetime”), while weekend and holiday television schedules may vary. Thus, according to this example, if the timeslot to be determined is on a weekday and not during “primetime,” the interactive television guide application may determine approximated information using historical content from the same timeslot from every weekday. However, if the timeslot is on a weekday during “primetime” or on a weekend, the interactive television guide application may only use historical content from the same timeslot from previous weeks. If the timeslot is on a holiday, the interactive television guide application may lack any relevant historical content and thus may not be able to make a determination. Thus, this exemplary approximation technique uses information about television scheduling to maximize the effectiveness of historical content in determining approximated information.

Similarly, the television season may affect the determination of approximated information. For example, television schedules may be more static during the “sweeps” periods of the television season. The “sweeps” periods corresponds to the select weeks during the year on which that television broadcasters measure their audiences. Typically these “sweeps” periods are marked by programming aimed at attracting a large audience, such as, heavily advertised new episodes of popular shows. However, for example, during the summer months, the typical off-season for television, much of the regular television programming schedule may be replaced by repeated and less popular programming. As another example, special programming may be ignored as an outlier during the analysis of historical content. The President's “State of the Union” address, for example, is a once a year event and may not be used determining the program information for the following week. In some embodiments, television program listings may include tags or identifiers that may indicate that the television programs are, for example, one-time specials, mark the beginning of a new schedule, or indicate when a program will be repeated at a future time.

In some embodiments, more advanced statistical algorithms may be used to enhance the accuracy of the approximated information. For example, instead of searching for the program that is broadcast most frequently throughout the historical content, an algorithm may give different weights to different program listings. For example, program listings that are only a week old may be given relatively higher weights than program listings that are over one month old. In addition, the user may adjust the weights, weighting factors and other settings in making the determination. For example, the interactive television program guide application may assign a much higher weight (e.g., ½ out of 1) to the program that is just one week old than any of the previous weeks (e.g., 1/10 out of 1). In this example, the historical content may need to have at least six identical programs that are over a week old to outweigh the program that is only one week old. But, if the weight assigned to the program that is only one week old were reduced (e.g., to ⅕ out of 1), a smaller number of older programs would be able to outweigh it.

In some embodiments, the algorithm used to determine approximated information may use patterns to determine approximated program listings. This algorithm may, for example, determine approximated program listings for a program that is only broadcast every other week or a regular program that has been absent for a few weeks but is due to return. For example, in some embodiments the interactive television program guide application may use patterns to identify television programming that repeats every day, every week, or every month. An algorithm that is capable of recognizing patterns in television programming schedules may also be able to recognize patterns, such as, a television broadcaster that regularly presents encore performances of movies and shows throughout a day or a week at regular timeslots. A pattern recognition algorithm may also recognize that after a certain number of new episodes of a particular program that the next broadcast will probably be a repeat or vise versa. Alternatively patterns can be programmed into the interactive television application as logic rules.

In some embodiments, the interactive television program guide application may monitor the determinations to train a learning algorithm, such as a neural network algorithm or other suitable algorithm. Such an algorithm may continually evolve based on feedback from its performance and success at determining correct approximated information. The training period may be, for example, several hours, several days, or more, and may be open ended, if desired. Each interactive television program application may have its own learning algorithm or it may receive a master algorithm that could be remotely programmed into the interactive television program application on a regular basis.

The interactive television program guide application may implement one or multiple algorithms for determining approximated information. The algorithms may be similar to one of the embodiments described above, may be a combination of several of the embodiments described above, or may be a different embodiment than the algorithms described above. The algorithm used may be pre-set in the interactive television program guide application, set by the television service provider, or may be user-customizable. If the algorithm used by the interactive television program guide application is user-customizable, the user may have the option of choosing an algorithm or algorithms from a list, customizing the algorithm or algorithms by inputting parameters that affect the algorithm performance (e.g., by entering custom weighting factors), or the user may be able to input custom algorithms. The interactive television program guide application may also monitor the performance and accuracy of the determinations of several algorithms, whether they are currently being used or not. The information on the performance and accuracy may be made available to the viewer in an interactive television program guide application display screen and may be transmitted, for example, to a television distribution facility which may collect such information from many interactive television program guide applications. The interactive television program guide application may modify the algorithm used or customize algorithm parameters based on this information or display suggestions for the user to do so.

One skilled in the art will appreciate that the invention can be practiced by other than the described embodiments, which are presented for purposes of illustration and not of limitation, and the present invention is limited only by the claims which follow.

1. A method for providing a user with access to interactive television program guide application features when information is not available, the method comprising:
receiving an indication from the user to select an interactive television program guide feature;
determining whether information associated with the selected feature is available in response to receiving the indication;
in response to determining that the information associated with the selected feature is not available, determining approximated information based on historical content of the information associated with the selected feature; and
providing the user with the selected feature having the approximated information.

2. The method of claim 1 wherein the selected feature comprises a television program listings information screen.

3. The method of claim 1 further comprising displaying the approximated information with different display characteristics than the available information.

4. The method of claim 1 further comprising determining the certainty of the determination of the approximated information.

5. The method of claim 1 further comprising permitting the user to edit the approximated information.

6. The method of claim 1 further comprising alerting the user when information is available for the selected feature having the approximated information.

7. The method of claim 1 further comprising alerting the user when the selected feature having the approximated information is changed.

8. An interactive television system for providing a user with access to interactive television program guide application features when information is not available, said interactive television system comprising:
an interactive television program guide application implemented at least partially on said interactive television system, said interactive television program guide application configured to:
receive an indication from the user to select a feature;
determine whether the information associated with the selected feature is available in response to receiving the indication;
in response to determining that the information associated with the selected feature is not available, determining approximated information based on historical content of the information associated with the selected feature; and
provide the user with the selected feature having the approximated information.

9. The system of claim 8 wherein the selected feature comprises a television program listings information screen.

10. The system of claim 8 wherein the interactive television program guide application is further configured to display the approximated information with different display characteristics than the available information.

11. The system of claim 8 wherein the interactive television program guide application
is further configured to determine the certainty of the determination of the approximated information.

12. The system of claim 8 wherein the interactive television program guide application is further configured to permit the user to edit the approximated information.

13. The system of claim 8 wherein the interactive television program guide application is further configured to alert the user when information is available for the selected feature having the approximated information.

14. The system of claim 8 wherein the interactive television program guide application is further configured to alert the user when the selected feature having the approximated information is changed.

15. Machine-readable media for use in an interactive television system for providing a user with access to interactive television program guide application features when information is not available, wherein the media is encoded with machine-readable instructions for:
receiving an indication from the user to select a feature;
determining whether information associated with the selected feature is available in response to receiving the indication;
in response to determining that the information associated with the selected feature is not available, determining approximated information based on historical content of the information associated with the selected feature; and
providing the user with the selected feature having the approximated information.

16. The machine-readable media of claim 15 wherein the selected feature comprises a television program listings information screen.

17. The machine-readable media of claim 15 further encoded with machine-readable instructions for display the approximated information with different display characteristics than the available information.

18. The machine-readable media of claim 15 further encoded with machine-readable instructions for determining the certainty of the determination of the approximated information.

19. The machine-readable media of claim 15 further encoded with machine-readable instructions for permitting the user to edit the approximated information.

20. The machine-readable media of claim 15 further encoded with machine-readable instructions for alerting the user when information is available for the selected feature having the approximated information.

21. The machine-readable media of claim 15 further encoded with machine-readable instructions for alerting the user when the selected feature having the approximated information is changed.
